(19) United States
(12) Patent Application Publication
(10) Pub. No.: US 2006/0209253 A1
(43) Pub. Date: Sep. 21, 2006

(54) Method and composition for eliminating ocular hypoxic acidosis

(76) Inventor: Brian C. Giles, Montecito, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/255,063

(22) Filed: Oct. 19, 2005

Related U.S. Application Data
(60) Provisional application No. 60/620,851, filed on Oct. 20, 2004.

(51) Int. Cl. G02C 7/04

(52) U.S. Cl. 351/160 R

(57) ABSTRACT

The methods and compositions of the present invention generally relate to ophthalmic solutions. Specifically, the methods and compositions relate to at least the following: ophthalmic solutions that are usable as eye drops for contact lens wearers, eye rinsing solutions, and ophthalmic solutions that are usable as contact lens wetting agents. In a wetting solution aspect, the present invention provides a contact lens wetting solution that includes: a cesium salt, a rubidium salt or a combination thereof; and, water, wherein the wetting solution has a viscosity of 1 to 3 cps.

### RELATED APPLICATION

This application claims priority to U.S. Provisional Patent Application Ser. No. 60/620,851 filed on Oct. 20, 2004, the entire disclosure of which is incorporated herein by reference.

### TECHNICAL FIELD

The methods and compositions of the present invention generally relate to ophthalmic solutions. More specifically, the methods and compositions relate to at least the following: ophthalmic solutions that are usable as eye drops for contact lens wearers, and ophthalmic solutions that are usable as contact lens wetting agents and eye rinsing solutions.

### BACKGROUND INFORMATION AND DISCUSSION OF RELATED ART

Serious complications are the primary reason for ceasing the use of contact lenses, some ocular conditions may lead to permanent visual impairment. A recent European study reported that between 6% to 12% of contact wearers (depending on the complications investigated) suffer from problems of intolerance to contact lenses. Similar percentages have been reported in the United States. Based on the large number of ca. 40 million contact lens wearers in the US, such complications are estimated to occur in 20 to 30 million patients.

The primary complication from contact lens wearing is chronic hypoxia and acidosis. It is currently known that wearers of all types of contact lenses, may experience a significant and long lasting or permanent degradation in all layers of the cornea (including the development of corneal edema) and suppression of the critical aerobic epithelial metabolism (compromising the optimum physiological ocular function).

In order to prevent hypoxia, contact lens manufacturers have developed materials for lenses through which oxygen can readily diffuse. Unfortunately, a substantial number of contact lens wearers still suffer from insufficient oxygenation and its concomitant effects.

During periods of corneal hypoxia, epithelial lactic acid production increases (increasing acidosis and hypoxia), resulting in osmotic imbalance. This leads to excessive stromal hydration, which is an indicator of corneal hypoxic acidosis (free radical propagation) and alters electro-physiological changes resulting in increased corneal thickness and in the development of a wide variety of disorders such as but not limited to epithelial microcysts, endothelial polymegethism, and other related contact-lens-induced keratopathies.

More oxygen permeable hard contact lenses have then been developed, some of which are suitable for extended use for about 1 week. However, they still have limitations in wearing comfort and the like. Additionally, soft contact lenses have been developed to improve wearing comfort. These flexible lenses show improved fitting comfort and are widely used. As previously mentioned, however, they have severe limitations.

When fitting contact lenses to the eyes, it is desirable that the lenses are made of hydrophilic materials with a wettable surface, so the lenses can be easily, accurately and safely fitted on the cornea, which is always dampened with lachrymal fluid. However, hard contact lenses and oxygen permeable hard contact lenses often lack sufficient wet agents, because they are often manufactured using hydrophobic materials such as polymethyl methacrylate and polysiloxanyl methacrylate.

Contact lens wetting solutions have been developed, which can form a hydrophilic layer on the surface of the contact lenses, improves the wettability of lenses made of hydrophobic material. However, these wetting solutions often contain thickening agents to promote fitting; the viscosity of the solutions usually reaches as high as 50 cps centipoises or even higher. These solutions often promote undesirable sticky feeling due to the existence of a highly viscous solution between the cornea and the contact lens. For example, the lachrymal fluid exchange between the cornea and a contact lens is reduced, which in turn causes oxygen deficiency (hypoxia) and induces a wide variety of ocular disorders such as corneal edema, corneal epithelial erosion, corneal endodermis cytotoxicity, etc.

Wetting solutions are not generally required for soft contact lenses because they are made of hydrophilic materials with higher water contents. Additionally, contact lenses often accumulate proteins and lipids in lachrymal fluid, and this characteristic is a substantial component in soft contact lenses. When they accumulate on the lens, the wettability of the lens surface is reduced. Accordingly, even in the case of soft contact lenses, the development of safe and effective wetting solution is needed.

The limitations discussed above are primarily caused by the duration of a condition where the lens surface cannot be sufficiently moistened by lachrymal fluid with an optimum or near optimum pH range. Contact lenses have properties that promote their surface becoming dry soon after contacting with the air in most cases. The thickness of the lens is about 100 μm, while the thickness of the lachrymal fluid aqueous layer is usually as thin as about 7 μm. Thus, it is difficult to keep contact lenses sufficiently wet with lachrymal fluid. Additionally, a contact lens is prone to adsorb waste products such as hydrophobic proteins and lipids contained in the tear fluids, which, when accumulated, repel water and make it more difficult for lachrymal fluid to sufficiently cover the surface of the lens.

When the lens surface becomes dry, ocular cells become dehydrated increasing acidosis and hypoxia, which further contributes to the damage caused by mechanical friction and dehydration. In addition, transparency of the lens is lowered, and its refraction-correcting property is deteriorated. Additionally, internal and external contaminants of tear are prone to adhere on the contact lenses, resulting in unpleasant feeling caused by the foreign materials, clouding of contact lenses and the decrease in wetting ability.

When such a condition occurs during the use of hard contact lenses, it has been treated with eye drops of artificial lachrymal fluid. However, because of the strong hydrophobicity characteristics of the contact lenses, the wetting effect is insufficient. In the case of soft contact lenses, the lenses themselves are hydrophilic and, therefore, eye drops for improving the wettability of the lens surface while wearing have not been sufficiently resolved. Therefore a suitable eye drops for soft contact lenses are needed in the art.

Anti-microbial agents are often formulated with preservatives in eye drops or eye wash or eye rinse solutions. Examples of such agents include p-hydroxybenzoate, benzalkonium chloride, benzethonium chloride, and chlorhexidine glucuronate. These compounds can cause refractory corneal epithelium disorders. Accordingly, there is a need in the art for ophthalmic solutions that do not contain these harmful anti-microbial agents.

### BRIEF SUMMARY OF THE INVENTION

### OBJECTS OF THE INVENTION

An object of the present invention is to provide ophthalmic solutions formulated with water-soluble compounds that have anti-microbial efficacy in a concentration range where the compound is not toxic to human cells, does not irritate the eye, is highly stable in aqueous solutions, and is difficult to be absorbed into the lens/lenses, and accumulated on hydrophilic contact lenses.

A further object of the present invention is to provide a composition that has reduced side effects, antimicrobial activity, and is optically stable.

The compositions of the present invention contain salts including ions of cesium and or rubidium. Such compositions have excellent antibacterial properties with low toxicity.

A further object of the invention is to provide an ophthalmic composition having regulated viscosity in association with a pharmaceutically acceptable ocular thickener. The composition typically has a viscosity ranging from 1 cps to 8 cps at 20° C.

A further object of the invention is to provide a contact lens wetting agent that does not include compounds that adsorb and accumulate on contact lenses, which are useful to improve the unpleasant feeling resulting from xerophthalmus.

A further object of the invention is to provide eye drops applicable while one is wearing contact lenses.

A further object of the invention is to provide an ocular rinse suitable for therapeutic gain.

A further object of the invention is to provide a contact lens cleaning agent and/or preserving liquid.

A further object of the invention is to provide solutions for disinfecting ophthalmic apparatuses.

A further object of the invention is to provide solutions that may be atomized to form a mist that is directly applied to the eyes for the purpose of hydration.

### DETAILED DESCRIPTION OF THE INVENTION

The pH range/value of the conjunctival fluid (tear fluid) of normal individuals, who do not wear contact lenses, has been reported to be a pH of about 6.93; that of contact lens wearers was shown to be a pH of about 6.66. This confirms the suboptimal acidotic state (reduced pH) of tear fluid of contact lens wearers. For an in-depth discussion on the effects of hypoxia and acidosis on contact lens wearers, see the following references, which are hereby incorporated-by-reference for all purposes: Corneal Acidosis (http://vision.berkeley.edu/polse/exp_acidosis.html); Corneal Effects (http://vision.berkeley.edu/polse/abst_acidosis.html#12moClinRes); Epithelial Barrier Function (http://vision.berkeley.edu/polse/exp_barrier.html); Barrier Function (http://vision.berkeley.edu/polse/abst_barrier.html#EPabstract4); Tear Exchange under Contact Lens (http://vision.berkeley.edu/polse/exp_tearflow.html); Tear Flow under Soft Contact Lenses (http://vision.berkeley.edu/polse/abst_tearflow.html); Post-Lens Tear Thickness (http://vision.berkeley.edu/polse/exp_tear thickness.html).

Hypoxia inevitably progresses to lowered pH ranges/values (acidosis). This is due to the dysregulation pumping mechanisms that remove metabolic residues (bicarbonate, organic acids) from the corneal cells into the vitreous humour particularly with the advancement of age. As a result of impaired and inefficient energy production, which further lowers the pH and increases the amounts of oxidative metabolic products (free radical propagation), “oxidative stress” is produced.

The pH range and osmotic condition of the cornea (turgor), the permeability of the corneal epithelial and endothelial cells, and their normal physiological metabolism determine the normal healthy structure and transparency of the corneal stroma. Under hypoxic acidosis conditions, the integrity and transport mechanisms in the membranes of the corneal cells and, consequently, their barrier function, are comprised.

The present invention discloses a composition for restoration of the electro-physiological mechanisms that are responsible for hypoxia and acidosis that lead to changes in corneal structure and function as a result of contact lens wear by administering a sufficient dosage of the composition to elevate the physiologically optimum pH ranges that compensate for the acidotic and hypoxic ocular environment are obtained.

Corneal physiological pH ranges between 7.40 to 7.65; when the eyes are open physiological pH ranges between 7.57 and 7.66. After contact lens wearers close their eye lids, the pH falls between 7.25 to 7.27 increasing acidic hypoxia.

Compositions of the present invention typically include: salts of alkalising metals, such as rubidium and cesium with potassium and magnesium (increasing pH, counteracting acidosis and oxidative stress; promoting cellular integrity and energy production; anti-microbial activity); water, preferably either a saline solution and or electro-chemical activation (E.C.A.) processed water solution with a negative O.R.P. (oxidation reduction potential) for anti-microbial activity, counteracting oxidative stress and with decreased surface tension (increased hydrating capacity, supporting corneal cell integrity and functional activity; and promotes removal of protein deposits from the lens material); and moisturizing substances that bind the water and minimize evaporation of tear fluid (counteracting the development of dry and red eyes).

These solutions can be used separately or in combination with others as contact lens care solutions (disinfection, preservation, cleaning, rewetting). The solutions do not require additional (toxic) disinfectants or preserving agents. Known antibacterial agents have wide clinical utility as therapeutic agents for infectious ocular diseases. These compounds, however, still have severe limitations for antimicrobial activity. Additionally, they are known to cause cytotoxicity and or photodermatosis (are not stable to light). Additionally, they are often tinted or colored and/or decompose when exposed to light. Thus, many limitations still remain unsolved.

Wearing hard contact lenses and have disadvantages such as inferior properties in feeling and lack sufficient oxygen permeability and thus contributes to hypoxia and free radical generation.

The ophthalmic solutions as presently described, wherein the salts containing ions of cesium and or rubidium have an adequate molecular weight, ensures that compounds are not substantially adsorbed onto and/or absorbed into hydrophilic contact lenses.

The ophthalmic solution as described, further typically comprises aspartic acid and/or a salt thereof. Examples of salts that may be used in the presently described ophthalmic solution include rubidium citrate, rubidium aspartate, rubidium aspartate, cesium citrate and cesium aspartate. As an example, the “ophthalmic solution” referred to in the invention indicates a solution that is directly applied to or contacts with ophthalmic tissues, as well as a solution for treating contact lenses or ophthalmic apparatuses.

The solution includes, for example, eye drops, eyewash solutions, eye-wetting and solutions for contact lens care and disinfectants for ophthalmic apparatuses. The solutions for contact lens care as referred herein include single- or multi-functional solutions for the care of contact lenses used as a disinfecting solution, a cleaning solution, a storing solution, a cleaning-storing solution, a cleaning-disinfecting-storing solution and the like. The compound salts included in the present compositions possesses sufficient microbiocidal activity and is generally larger in size than the pore size of the contact lens polymer matrix. As a consequence, it is poorly absorbed/adsorbed onto contact lenses. The composition has a broad anti-microbial spectrum and exhibited biocidal activity and fungi at low concentration. The compound is highly safe for the eyes.

The local pH range of the tear fluid on the corneal surface can be elevated to more physiologically optimum alkaline values that compensate for the acidotic and hypoxic condition. This can be achieved by administering a composition containing salts of rubidium and or cesium for (increasing pH, counteracting acidosis and oxidative stress; promoting cellular integrity and energy production; anti-microbial activity). The quality and the quantity of the tear film is influenced by internal (immune system, aging) and external factors (mechanical damage, e.g. resulting from contact lens wear, environmental conditions, such as working with computer monitors, etc.). Impaired tear production and/or tear quality may lead to increased evaporation, additional mechanical stress on the corneal and conjunctival cells and to inflammatory reactions are associated with oxidative stress and acidosis, a reduced suboptimal pH. The solutions mentioned are also applicable to eye drops against red irritated or itchy eyes; comfort drops against eye fatigue, etc.

The ophthalmic solutions of the present invention are formulated with a cesium salt and/or rubidium salt, with cesium or rubidium ions or a combination of the two being present at a concentration ranging from 10 ppm to 100,000 ppm, preferably from 10 ppm to 10,000 ppm. Disinfectants for ophthalmic apparatuses, for example, are typically formulated using the ions at a concentration ranging from 10 ppm to 250,000 ppm; eyedrops, eyewash solutions, eye rinse, cleaning solutions, storing solutions, or cleaning-storing solutions used for contact lens care are typically formulated using the salt(s) at a concentration ranging from 500 ppm to 200,000 ppm, preferably 1000 ppm to 100,000 ppm; disinfectants and cleaning-disinfecting-storing solutions used for contact lens care are typically formulated using the salt(s) at a concentration ranging from 100 ppm to 100,000 ppm, preferably from 500 ppm to 50,000 ppm.

The pH of the ophthalmic solutions of the present invention may be of any suitable physiological range value. The pH value usually ranges from 6.00 to 8.50, preferably from 7.30 to 7.90. The osmotic pressure ratio (the ratio of osmotic pressure of the ophthalmic solution to the osmotic pressure of physiological saline) is usually adjusted to about 0.5 to 5.0, preferably adjusted to about 0.8 to 2.0. The ophthalmic solutions of the present invention can be formulated with a wide variety of ingredients in the composition. Any suitable ingredient may be contained in the solutions that does not interfere with ionic mobility/dissociation.

For example, the solutions may be formulated with a variety of additives such as but not limited to buffering agents, isotonizing agents, solubilizers, stabilizers, viscoelastic agents, chelating agents, and pH-adjusting agents as well as other active ingredients such as agents for removing congestion, anti-inflammatory agents, astringents, antihistaminic agents, anti-microbial agents, vitamins, amino acids, inorganic salts, and saccharides. For example, the solutions may also contain coloring agents such as 1-menthol. The buffering agents include, for example, but not limited to, borate buffer, phosphate buffer, carbonate buffer, acetate buffer, citrate buffer, e-aminocapronic acid, glutamic acid and salts thereof, and aspartic acid and salts thereof. The isotonizing agents include, for example, sodium chloride, potassium chloride, calcium chloride, glycerol, glucose, mannitol, aminoethyl sulfonic acid, aspartic acid, potassium aspartate, sodium aspartate, and magnesium potassium aspartate. In particular, the preferable isotonizing agents are aspartic acid and/or salts thereof; the preferred salts are sodium aspartate, potassium aspartate, and magnesium aspartate.

The ophthalmic solutions are typically formulated with a solution of aspartic acid and/or salts thereof, which is isotonic with 0.5 to 2.0% sodium chloride solution. Solutions containing aspartic acid, or other acids such as citrate, and/or its salts, include the compound at a concentration adjusted within a range where there are no adverse influences on the properties of soft contact lenses (e.g., lens shape) are preferably used as solutions for contact lens care.

Chelating agents that may be used in the present compositions include, for example, EDTA, calcium edetate, sodium edetate, germanium sesquaoxide and citric acid and salts thereof. The pH-adjusting agents that may be used in the present compositions include, without limitation, sodium hydroxide, potassium hydroxide, potassium citrate, sodium carbonate, hydrochloric acid, acetic acid, citric acid, and phosphoric acid. To improve the detergency, the solutions for cleaning, disinfecting, and/or storing contact lenses can be formulated with, for example but not limited to nonionic surfactants, amphoteric surfactants, or anionic surfactants.

Examples of thickener useable in the ophthalmic composition of the present invention may include gum arabic powder, sodium alginate, propylene glycol alginate, sodium chondroitin sulfate, sorbitol, dextran 70, tragacanth powder, sodium carboxymethyl cellulose, hydroxyethyl cellulose, hydroxypropylmethyl cellulose, carboxyvinyl polymer, triisopropanolamine, polyvinyl alcohol, polyvinylpyrrolidone and Macrogol 4000. Among them, hydroxyethyl cellulose, hydroxypropylmethyl cellulose, polyvinyl alcohol and polyvinylpyrrolidone are preferred because they give a solution of an appropriate viscosity even at low concentrations. Hydroxyethyl cellulose and polyvinylpyrrolidone are more preferred since they are highly safe and generally do not affect contact lenses.

Anti-oxidants are preferably included in the compositions but are not essential. Nonlimiting examples of such anti-oxidants include butylated hydroxyanisol or ascorbic acid, and preferably sodium thiosulfate or butylated hydroxytoluene.

Where included, the anti-oxidant should be present at concentrations below which it causes irritation of the eyes. Typically the concentration of anti-oxidant should be within the range from 50 ppm to 100,000 ppm, preferably from 100 ppm to 10,000 ppm to avoid irritation of the eye.

Also, for example, instead of an anti-oxidant, the ophthalmic composition may be stored in a container containing nitrogen and optionally including a free oxygen absorber.

If desired other excipients may be present—for example an isotonic agent, buffer, preservative, and/or pH-controlling agent. Sterile purified saline water or E.C.A. processed water in appropriate amounts may be present to obtain the desired eye-drop preparation.

The ophthalmic compositions may be filled in appropriate containers to facilitate administration to the eye, for example a dropper fitted with a suitable pipette.

The composition for eye drops of the present invention can be obtained by dissolving the rubidium and/or cesium salt or salts in water together with the composition according to the present invention, optionally containing a water-soluble polymeric compound in addition to cyclodextrin. The water-soluble polymeric compound is a pharmaceutically acceptable water-soluble carrier.

Any combination of cesium and/or rubidium salts, combined with an acid or anion, which dissociate and ionize may be employed in the composition of the present invention, including, but not limited to: Arginate, Ascorbate, Aspartate, Caprylate, Chloride, Cysteinate, Citrate, Fumarate, Humic, Fulvate, Methionine, Glutamate, Gluconate, Glycinate, Lysinate, Succinate, Carbonate, Lactate, Malate, Tartrate, Sulfate, Phosphate, Nitrate, Fluoride, Bromide, Iodide, Orotate, Asporotate, Bisulfonate, Lysinate, Fulvic, Succate, Carnate, Trisulfate, Lactobionate, Benzenesulfonate, Laurate, Benzoate, Bicarbonate, Benzoic, Caseinate, Bisufate, Mandelate, Bitartrate, Mesylate, Borate, Methylbromide, Calcium Edetate, Methylsulfate, Camsylate, Mucate, Napsylate, Clavulanate, N-Methylglucamine, Ammonium Salt, Dihydrochloride, Oleate, Edetate, Oxalate, Edisylate, Pamoate (Embonate), Esolate, Palmitate, Esylate, Pantothenate, Phosphate/Diphosphate, Gluceptate, Polygalacturonate, Salicylate, Stearate, Glycollylarsanilate, Hexylresorcinate, Subacetate, Hydrabamine, Hydrobromide, Tannate, Hydrochloride, Hydroxynaphthoate, Teoclate, Tosylate, Isothionate, Triethiodide, Panoate, Valerate, Acetate, Malonate and mixtures thereof.

There is variability in the ionization capability of the various salts of cesium and rubidium with some ionizing more readily than others. The toxicity of the salts of cesium and rubidium will depend on the salt combinations. As examples, but not limited to the carbonate, chloride, citrate and sulfate salts are safer, the phosphate is relatively safe, while others have various levels of toxicity and should be used with caution. The organic forms are most preferred.

Additionally or alternately, other salts might be used in the current invention, including various organic or metallic salts, if they meet the following requirements: (1) they must be pharmaceutically acceptable and have an acceptably low level of toxicity; (2) they must have sufficiently high levels of solubility in water or a buffered saline solution; (3) they must be stable in an alkaline solution having a pH value from 6.80 to 7.90, in water or a buffered saline solution; and, (4) they must have sufficiently high levels of cationic (alkaline) dissociation to allow the remaining cesium and or rubidium ions to effectively reduce the acidity of ocular tissues and fluids. Lists of suitable salts are found in Remington's Pharmaceutical Sciences, 17^{th} ed., Mack Publishing Company, Easton, Pa. 1985, p. 1418, the disclosure of which is hereby incorporated by reference.

The compounds or salts thereof can exist not only in unsolvated forms but also in hydrated or solvated forms. Accordingly, the compounds of the present invention embrace those in any crystalline form, and hydrated and solvated forms. The compounds or salts thereof are prepared by any desired process.

It is preferred that the viscosity of the present composition is 1 to 3 cps. When the viscosity is 3 cps or less, the moistening effect of the composition increases and the feel while wearing lenses is improved to an extent similar to that attainable by conventional eye drops. The viscosity of the present composition should not be less than 1 cps when measured at 20° C., because the viscosity of E.C.A. processed water or saline may be used as a solvent for contact lens wetting agent and eye drops of the present invention is equal to or less than 1 cps at 20° C. It may be necessary to adjust the viscosity of the composition within the ranges as defined above for each case in accordance with a method known in the art, considering a combination of a poloxamer or poloxamine selected and a thickener, and also the kind of an additive(s).

Further, due to the low viscosity, the lachrymal fluid exchange between the cornea and a contact lens is hardly inhibited and, therefore, the occurrence of ocular disorders due to acidic hypoxia (oxygen deficiency and reduced pH) including corneal edema, corneal epithelial erosion, corneal endodermis cytotoxicity, and the like can be prevented. These disorders are particularly serious in the case of a soft contact lens which has a large diameter and covers the whole area of cornea and is prone to closely adhere to cornea due to its flexibility. In addition, soft contact lenses hardly get wet at a viscosity of 8 cps or more, and it becomes quite difficult to handle the lenses. According to the composition of the present invention, such a limitation can be remedied.

A method for improving the moistening effect of an aqueous ophthalmic composition for contact lens on a surface (non-limiting) is provided. The method comprises adding polyoxyethylene or polyoxypropylene glycol to the composition at a concentration of between 0.001-10% and a pharmaceutically acceptable thickener and adjusting viscosity of the composition to between 1 cps and 8 cps at 20° C.

Method of Manufacture

An example of a method of manufacture is to use water, preferably processed by E.C.A., to obtain a wide range of concentrations, altering the solution's electro-viscous and electro-chemical characteristics. A wide variety of cesium and/or rubidium salts can be introduced into the aqueous ocular composition altering the viscosity and surface tension to the desired range to suit a wide variety of uses.

As an example, lowering the surface tension improves hydration and nutrient support uptake and lactic acid elimination. Preferably, such a solution has an ORP ranging from +10 m.v. to −350 m.v, preferably −120 m.v. to −250 m.v., more preferably −125 m.v. to −200 m.v. For aqueous ocular solutions, the composition pH ranges from 6.50 to 7.90, preferably 7.31 to 7.75.

The salt or salts of the present invention can be synthesized from the compound, which contains a basic or acidic moiety by conventional chemical methods. Generally, such salts can be prepared by reacting with the free acid or base forms of these compounds with a predetermined amount of the appropriate base or acid in water or in an organic solvent, or in a mixture of the two.

In a preferred embodiment the composition provides an oil-free ophthalmic composition comprising: a suitably purified and E.C.A. processed water.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

### EXAMPLES

Formulation Example (Eye Drop).

In 100 ml of E.C.A. processed water was dissolved 0.3 g of a cesium salt, followed by the addition of a buffer and sodium chloride, whereby an isotonic solution of pH ranging between 7.31 to 7.70 was obtained. A sterilized container was filled with 5 ml of the resulting solution, whereby an eye drop containing 0.3% of the cesium salt was obtained. The compounds or salts thereof according to the present invention exhibit light stability, while maintaining excellent antibacterial activity and excellent phototoxicity-free properties. Antibacterial agents comprising, as an active ingredient, the invention compound or salt thereof can be stored over a long period of time without suffering from a decrease in the effect.

1. A contact lens wetting solution, wherein the composition comprises:
a) a cesium salt, a rubidium salt or a combination thereof; and,
b) water,
c) wherein the wetting solution has a viscosity of 1 to 3 cps.

2. The contact lens wetting solution according to claim 1, wherein the solution comprises a cesium salt selected from a group of Aspartate, Citrate, Fumarate, Humic, Fulvic, Fulvate, Methionine, Glutamate, Gluconate, Glycinate, Lysinate, Succinate, Carbonate, chloride, Lactate, Malate, Tartrate, Sulfate, Phosphate, Nitrate, Fluoride, Bromide, Iodide, Orotate, Asporotate, Aspartate, Bisulfonate, Lysinate, Fulvic, Succate, Carnate, Trisulfate, Lactobionate, Benzenesulfonate, Laurate, Benzoate, Bicarbonate, Benzoic, Caseinate, Bisufate, Mandelate, Bitartrate, Mesylate, Borate, Methylbromide, Calcium Edetate, Methylsulfate, Camsylate, Mucate, Napsylate, Clavulanate, N-Methylglucamine, Ammonium Salt, Dihydrochloride, Oleate, Edetate, Oxalate, Edisylate, Pamoate (Embonate), Esolate, Palmitate, Esylate, Pantothenate, Phosphate/Diphosphate, Gluceptate, Polygalacturonate, Salicylate, Stearate, Glycollylarsanilate, Hexylresorcinate, Subacetate, Hydrabamine, Hydrobromide, Tannate, Hydrochloride, Hydroxynaphthoate, Teoclate, Tosylate, Isothionate, Triethiodide, Panoate, Valerate, Acetate, Malonate and mixtures thereof.

3. The contact lens wetting solution according to claim 1, wherein cesium ions, rubidium ions or combination thereof, are present in the solution at a concentration ranging from 10 ppm to 100,000 ppm.

4. The contact lens wetting solution according to claim 1, wherein the water is in the form of a saline solution.

5. A disinfectant solution for an ophthalmic apparatus, wherein the composition comprises:
a) a cesium salt, a rubidium salt or a combination thereof; and,
b) water,
wherein the solution has an ORP from −25 m.v. to −350 m.v.

6. The disinfectant solution according to claim 5, wherein the disinfectant comprises a cesium salt selected from a group of cesium salts consisting of Arginate, Ascorbate, Aspartate, Caprylate, Chloride, Cysteinate, Citrate, Fumarate, Humic, Fulvate, Methionine, Malate, Glutamate, Gluconate, Glycinate, Lysinate, Succinate, Carbonate, Lactate, Chloride, Malate, Tartrate, Sulfate, Phosphate, Nitrate, Fluoride, Bromide, Iodide, Orotate, Asporotate, Bisulfonate, Lysinate, Fulvic, Succate, Carnate, Trisulfate, Lactobionate, Benzenesulfonate, Laurate, Benzoate, Bicarbonate, Benzoic, Caseinate, Bisufate, Mandelate, Bitartrate, Mesylate, Borate, Methylbromide, Methylnitrate, Calcium Edetate, Methylsulfate, Camsylate, Mucate, Napsylate, Clavulanate, N-Methylglucamine, Ammonium Salt, Dihydrochloride, Oleate, Edetate, Oxalate, Edisylate, Pamoate (Embonate), Esolate, Palmitate, Esylate, Pantothenate, Phosphate/Diphosphate, Gluceptate, Polygalacturonate, Salicylate, Stearate, Glycollylarsanilate, Hexylresorcinate, Subacetate, Hydrabamine, Hydrobromide, Tannate, Hydrochloride, Hydroxynaphthoate, Teoclate, Tosylate, Isothionate, Triethiodide, Panoate, Valerate, Acetate, Malonate and mixtures thereof.

7. The disinfectant solution according to claim 5, wherein cesium ions, rubidium ions or combination thereof, are present in the solution at a concentration ranging from 10 ppm to 10,000 ppm.

8. The disinfectant solution according to claim 5, wherein the solution further comprises a nonionic surfactant, an amphoteric surfactant, or an anionic surfactant.

9. The disinfectant solution according to claim 5, wherein the solution has an ORP from −25 m.v. to −350 m.v.

10. An eyedrop solution for use by a contact lens wearer, wherein the composition comprises:
a) a cesium salt, rubidium salt or combination thereof;
b) water; and,
c) a water-soluble polymer.

11. The eyedrop solution according to claim 10, wherein the water-soluble polymer is a pharmaceutically acceptable water-soluble carrier.

12. The eyedrop solution according to claim 10, wherein the solution comprises cesium ions present at a concentration ranging from 10 ppm to 10,000 ppm.

13. The eyedrop solution according to claim 10, wherein the solution comprises a cesium salt selected from a group of cesium salts consisting of Arginate, Ascorbate, Aspartate, Caprylate, Chloride, Cysteinate, Citrate, Fumarate, Humic, Fulvate, Methionine, Glutamate, Gluconate, Glycinate, Lysinate, Succinate, Carbonate, Lactate, Malate, Tartrate, Sulfate, Phosphate, Nitrate, Fluoride, Bromide, Iodide, Orotate, Asporotate, Bisulfonate, Lysinate, Fulvic, Succate, Camate, Trisulfate, Lactobionate, Benzenesulfonate, Laurate, Benzoate, Bicarbonate, Benzoic, Caseinate, Bisufate, Mandelate, Bitartrate, Mesylate, Borate, Methylbromide, Methylnitrate, Calcium Edetate, Methylsulfate, Camsylate, Mucate, Napsylate, Clavulanate, N-Methylglucamine, Ammonium Salt, Dihydrochloride, Oleate, Edetate, Oxalate, Edisylate, Pamoate (Embonate), Esolate, Palmitate, Esylate, Pantothenate, Phosphate/Diphosphate, Gluceptate, Polygalacturonate, Salicylate, Stearate, Glycollylarsanilate, Hexylresorcinate, Subacetate, Hydrabamine, Hydrobromide, Tannate, Hydrochloride, Hydroxynaphthoate, Teoclate, Tosylate, Isothionate, Triethiodide, Panoate, Valerate, Acetate, Malonate and mixtures thereof.

14. The eyedrop solution according to claim 10, wherein the solution further comprises a thickener, and wherein the thickener is selected from a group consisting of gum arabic powder, sodium alginate, propylene glycol alginate, sodium chondroitin sulfate, sorbitol, dextran 70, tragacanth powder, sodium carboxymethyl cellulose, hydroxyethyl cellulose, hydroxypropylmethyl cellulose, carboxyvinyl polymer, triisopropanolamine, polyvinyl alcohol, polyvinylpyrrolidone and Macrogol 4000™.

15. A kit for contact lens wetting, wherein the kit comprises:
a) an aqueous solution comprising a cesium salt, a rubidium salt or a combination thereof; and,
b) instructions on how one should use the solution in a contact lens wetting process.

16. The kit according to claim 15, wherein the solution has a viscosity of 1 to 3 cps.

17. The kit according to claim 15, wherein the solution comprises a cesium salt selected from a group consisting of Arginate, Ascorbate, Aspartate, Caprylate, Chloride, Cysteinate, Citrate, Fumarate, Humic, Fulvate, Methionine, Glutamate, Gluconate, Glycinate, Lysinate, Succinate, Carbonate, Lactate, Malate, Tartrate, Sulfate, Phosphate, Nitrate, Fluoride, Bromide, Iodide, Orotate, Asporotate, Bisulfonate, Lysinate, Fulvic, Succate, Carnate, Trisulfate, Lactobionate, Benzenesulfonate, Laurate, Benzoate, Bicarbonate, Benzoic, Caseinate, Bisufate, Mandelate, Bitartrate, Mesylate, Borate, Methylbromide, Methylnitrate, Calcium Edetate, Methylsulfate, Camsylate, Mucate, Napsylate, Clavulanate, N-Methylglucamine, Ammonium Salt, Dihydrochloride, Oleate, Edetate, Oxalate, Edisylate, Pamoate (Embonate), Esolate, Palmitate, Esylate, Pantothenate, Phosphate/Diphosphate, Gluceptate, Polygalacturonate, Salicylate, Stearate, Glycollylarsanilate, Hexylresorcinate, Subacetate, Hydrabamine, Hydrobromide, Tannate, Hydrochloride, Hydroxynaphthoate, Teoclate, Tosylate, Isothionate, Triethiodide, Panoate, Valerate, Acetate, Malonate and mixtures thereof.

18. The kit according to claim 15, wherein cesium ions, rubidium ions or combination thereof, are present in the solution at a concentration ranging from 10 ppm to 100,000 ppm.

19. The kit according to claim 15, wherein the solution has an ORP from +10 m.v. to −350 m.v

20. A kit for the administration of eyedrops to a contact lens wearer, wherein the kit comprises:
a) a aqueous solution comprising a cesium salt, rubidium salt or combination thereof; and,
b) instructions on how a contact lens wearer should use the eyedrops.

21. The kit according to claim 20, wherein the solution further comprises a water soluble polymer.

22. The kit according to claim 20, wherein the solution comprises a cesium salt selected from a group of cesium salts consisting of Arginate, Ascorbate, Aspartate, Caprylate, Chloride, Cysteinate, Citrate, Fumarate, Humic, Fulvate, Methionine, Glutamate, Gluconate, Glycinate, Lysinate, Succinate, Carbonate, Lactate, Malate, Tartrate, Sulfate, Phosphate, Nitrate, Fluoride, Bromide, Iodide, Orotate, Asporotate, Bisulfonate, Lysinate, Fulvic, Succate, Carnate, Trisulfate, Lactobionate, Benzenesulfonate, Laurate, Benzoate, Bicarbonate, Benzoic, Caseinate, Bisufate, Mandelate, Bitartrate, Mesylate, Borate, Methylbromide, Methylnitrate, Calcium Edetate, Methylsulfate, Camsylate, Mucate, Napsylate, Clavulanate, N-Methylglucamine, Ammonium Salt, Dihydrochloride, Oleate, Edetate, Oxalate, Edisylate, Pamoate (Embonate), Esolate, Palmitate, Esylate, Pantothenate, Phosphate/Diphosphate, Gluceptate, Polygalacturonate, Salicylate, Stearate, Glycollylarsanilate, Hexylresorcinate, Subacetate, Hydrabamine, Hydrobromide, Tannate, Hydrochloride, Hydroxynaphthoate, Teoclate, Tosylate, Isothionate, Triethiodide, Panoate, Valerate, Acetate, Malonate and mixtures thereof.

23. The kit according to claim 20, wherein the solution further comprises a thickener, and wherein the thickener is selected from a group consisting of gum arabic powder, sodium alginate, propylene glycol alginate, sodium chondroitin sulfate, sorbitol, dextran 70, tragacanth powder, sodium carboxymethyl cellulose, hydroxyethyl cellulose, hydroxypropylmethyl cellulose, carboxyvinyl polymer, triisopropanolamine, polyvinyl alcohol, polyvinylpyrrolidone and Macrogol 4000.

24. The kit according to claim 20, wherein the solution has an ORP from +10 m.v. to −350 m.v

25. A system for disinfecting contact lenses, wherein the system comprises:
a) an aqueous solution comprising a cesium salt, a rubidium salt or a combination thereof; and,
b) an ophthalmic disinfecting device.

26. The system according to claim 25, wherein the solution has an ORP from +10 m.v. to −350 m.v.

27. The system according to claim 25, wherein the solution comprises a cesium salt selected from a group of cesium salts consisting of Arginate, Ascorbate, Aspartate, Caprylate, Chloride, Cysteinate, Citrate, Fumarate, Humic, Fulvate, Methionine, Glutamate, Gluconate, Glycinate, Lysinate, Succinate, Carbonate, Lactate, Malate, Tartrate, Sulfate, Phosphate, Nitrate, Fluoride, Bromide, Iodide, Orotate, Asporotate, Bisulfonate, Lysinate, Fulvic, Succate, Carnate, Trisulfate, Lactobionate, Benzenesulfonate, Laurate, Benzoate, Bicarbonate, Benzoic, Caseinate, Bisufate, Mandelate, Bitartrate, Mesylate, Borate, Methylbromide, Methylnitrate, Calcium Edetate, Methylsulfate, Camsylate, Mucate, Napsylate, Clavulanate, N-Methylglucamine, Ammonium Salt, Dihydrochloride, Oleate, Edetate, Oxalate, Edisylate, Pamoate (Embonate), Esolate, Palmitate, Esylate, Pantothenate, Phosphate/Diphosphate, Gluceptate, Polygalacturonate, Salicylate, Stearate, Glycollylarsanilate, Hexylresorcinate, Subacetate, Hydrabamine, Hydrobromide, Tannate, Hydrochloride, Hydroxynaphthoate, Teoclate, Tosylate, Isothionate, Triethiodide, Panoate, Valerate, Acetate, Malonate and mixtures thereof.

28. The system according to claim 25, wherein cesium ions, rubidium ions or combination thereof, are present in the solution at a concentration ranging from 10 ppm to 10,000 ppm.

29. The system according to claim 25, wherein the solution further comprises a nonionic surfactant, an amphoteric surfactant, or an anionic surfactant.

30. The system according to claim 25, wherein the solution has an ORP from +10 m.v. to −350 m.v.
